(19) United States
(12) Patent Application Publication
(10) Pub. No.: US 2015/0347610 A1
(43) Pub. Date: Dec. 3, 2015

(54) METHODS AND APPARATUS FOR MODIFYING A PLURALITY OF MARKUP LANGUAGE FILES

(71) Applicant: kCura Corporation, Chicago, IL (US)

(72) Inventors: Gaurav Vempati, Chicago, IL (US); Douglas Walter Stevens, Naperville, IL (US)

(73) Assignee: kCura Corporation, Chicago, IL (US)

(21) Appl. No.: 14/294,610

(22) Filed: Jun. 3, 2014

(51) Int. Cl. G06F 17/30

(52) U.S. Cl. CPC G06F 17/30896; G06F 17/30011; G06F 17/30076

(57) ABSTRACT

Methods and apparatus for modifying a plurality of markup language files are disclosed. In general, web pages are renamed as they are brought in to a document review application, and a data structure is created that associates the old name of each web page with the new name of each web page. Then, all of the links in the web pages are modified to also use the new names. As a result, users of the document review application may review the web pages with functional links.

The present disclosure relates in general to databases, and, in particular, to methods and apparatus for modifying a plurality of markup language files.

### BACKGROUND

The vast majority of documents we create and/or archive are stored electronically. In order to quickly find certain documents, the relevant data from these documents is typically extracted, catalogued, and organized in a database to make them searchable in a document review application. For example, as part of the discovery process in a law suit, millions of documents may need to be reviewed.

One type of document that is frequently reviewed is a web page. Web pages are defined by a markup language file, such as a hypertext markup language (HTML) file. Web pages typically contain links to other web pages, and the path to the linked web page is stored in the markup language file. However, the process of bringing the documents in to the document review application typically renames the files, thereby breaking these links.

### BRIEF DESCRIPTION OF THE DRAWINGS

FIG. 1 is a block diagram of an example network communication system.

FIG. 2 is a block diagram of an example computing device.

FIG. 3 is a flowchart of an example process for modifying a plurality of markup language files.

FIG. 4 is an example markup language file before and after having an HREF attribute modified.

FIG. 5 is an example markup language file before and after having an IMG tag modified.

FIG. 6 is an example markup language file before and after having an style sheet tag modified.

FIG. 7 is an example of a portion of an HTML file before and after footer information is removed.

### DETAILED DESCRIPTION OF THE PREFERRED EMBODIMENTS

Briefly, methods and apparatus for modifying a plurality of markup language files are disclosed. In general, web pages are renamed as they are brought in to a document review application, and a data structure is created that associates the old name of each web page with the new name of each web page. Then, all of the links in the web pages are modified to also use the new names. As a result, users of the document review application may review the web pages with functional links.

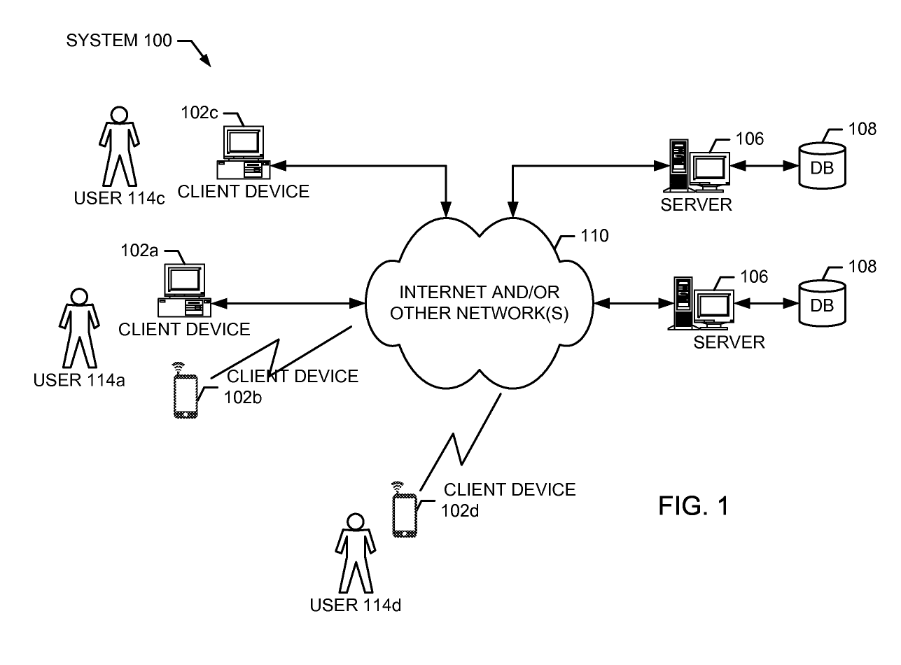

Turning now to the figures, the present system is most readily realized in a network communication system 100. A block diagram of certain elements of an example network communications system 100 is illustrated in FIG. 1. The illustrated system 100 includes one or more client devices 102 (e.g., computer, television, camera, phone), one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

In this example, user 114a is using client device 102a and client device 102b. For example, user 114a may be reviewing documents displayed on a desktop display of client device 102a and coding those documents using a touch screen on client device 102b.

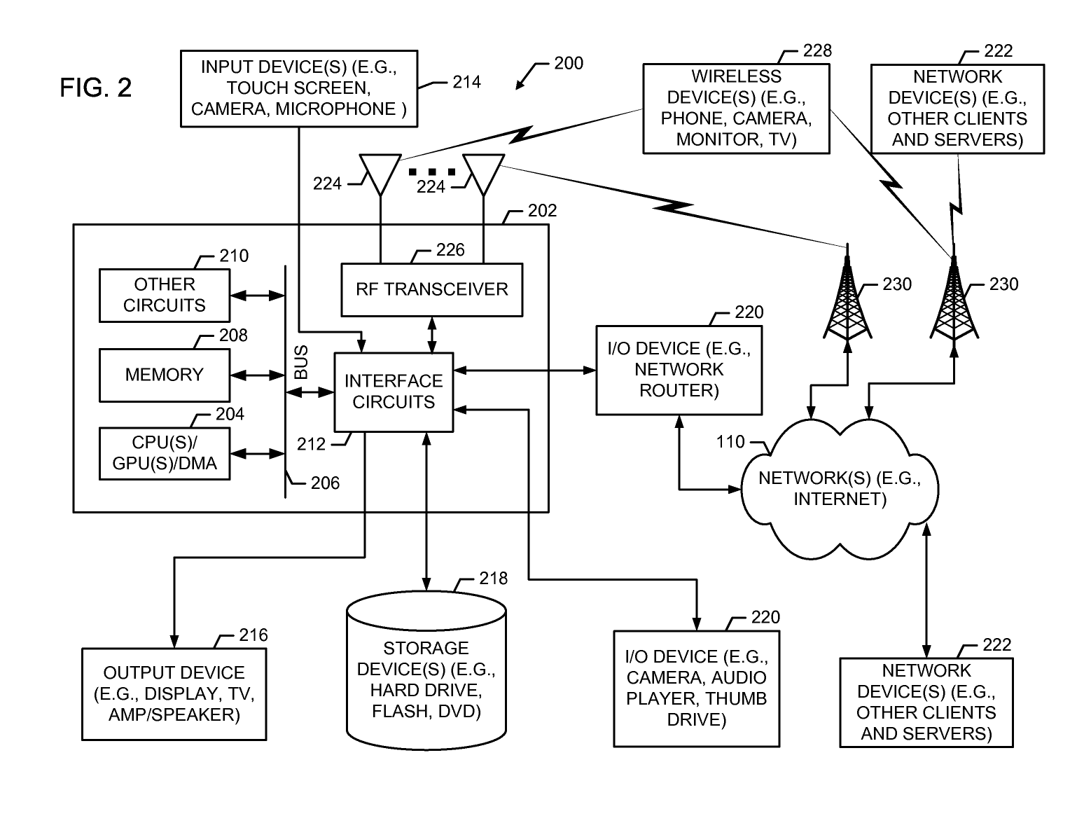

Each of the devices illustrated in FIG. 1 (e.g., clients 102 and/or servers 106) may include certain common aspects of many computing devices such as microprocessors, memories, input devices, output devices, etc. FIG. 2 is a block diagram of an example computing device. The example computing device 200 includes a main unit 202 which may include, if desired, one or more processing units 204 electrically coupled by an address/data bus 206 to one or more memories 208, other computer circuitry 210, and one or more interface circuits 212. The processing unit 204 may include any suitable processor or plurality of processors. In addition, the processing unit 204 may include other components that support the one or more processors. For example, the processing unit 204 may include a central processing unit (CPU), a graphics processing unit (GPU), and/or a direct memory access (DMA) unit.

The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processing unit 204 in any suitable manner. The memory 208 may also store digital data indicative of documents, files, programs, web pages, etc. retrieved from a server and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, camera, voice recognition system, accelerometer, global positioning system (GPS), and/or any other suitable input device.

One or more displays, printers, speakers, monitors, televisions, high definition televisions, and/or other suitable output devices 216 may also be connected to the main unit 202 via the interface circuit 212. One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 200. The computing device 200 may also exchange data with one or more input/output (I/O) devices 220, such as network routers, camera, audio players, thumb drives etc.

The computing device 200 may also exchange data with other network devices 222 via a connection to a network 110. The network connection may be any type of network connection, such as an Ethernet connection, digital subscriber line (DSL), telephone line, coaxial cable, wireless base station 230, etc. Users 114 of the system 100 may be required to register with a server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

In some embodiments, the device 200 may be a wireless device 200. In such an instance, the device 200 may include one or more antennas 224 connected to one or more radio frequency (RF) transceivers 226. The transceiver 226 may include one or more receivers and one or more transmitters operating on the same and/or different frequencies. For example, the device 200 may include a blue tooth transceiver 216, a Wi-Fi transceiver 216, and diversity cellular transceivers 216. The transceiver 226 allows the device 200 to exchange signals, such as voice, video and any other suitable data, with other wireless devices 228, such as a phone, camera, monitor, television, and/or high definition television. For example, the device 200 may send and receive wireless telephone signals, text messages, audio signals and/or video signals directly and/or via a base station 230.

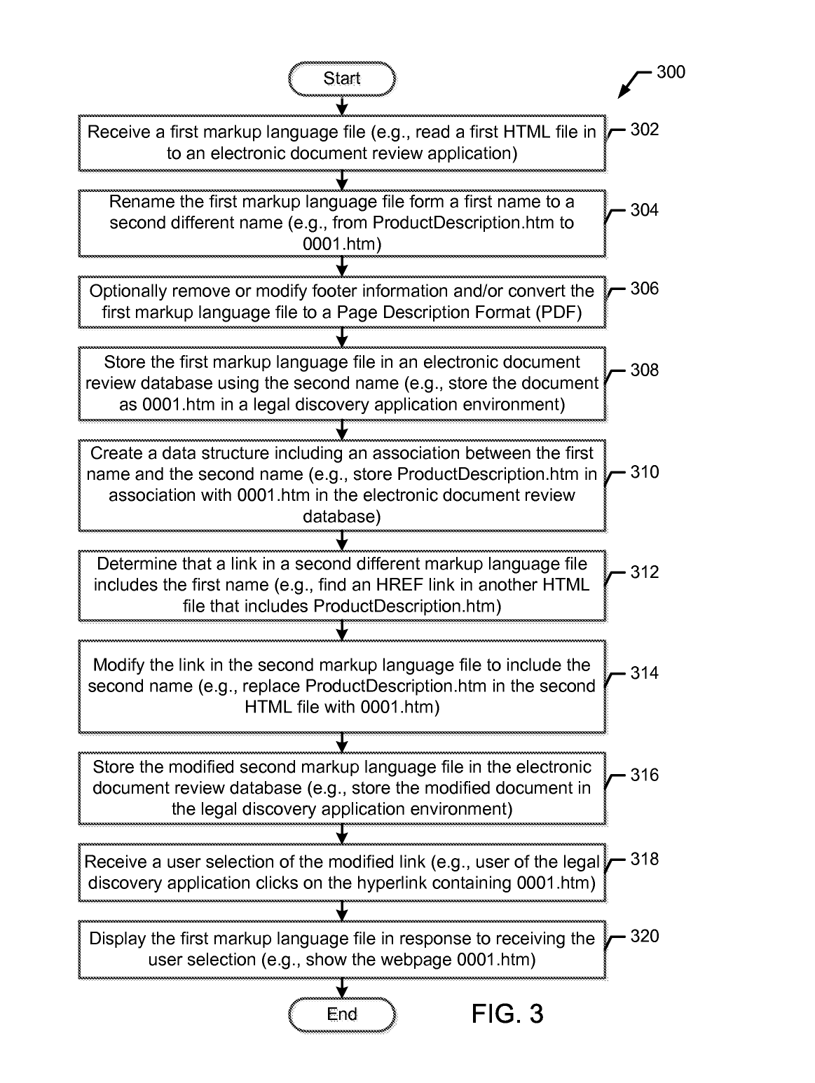

FIG. 3 is a flowchart of an example process for modifying a plurality of markup language files. The process 300 may be carried out by one or more suitably programmed processors, such as a CPU executing software (e.g., block 204 of FIG. 2). The process 300 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 300 is described with reference to the flowchart illustrated in FIG. 3, it will be appreciated that many other methods of performing the acts associated with process 300 may be used. For example, the order of many of the operations may be changed, and some of the operations described may be optional.

In general, web pages are renamed as they are brought in to a document review application, and a data structure is created that associates the old name of each web page with the new name of each web page. Then, all of the links in the web pages are modified to also use the new names. As a result, users of the document review application may review the web pages with functional links.

More specifically, in this example, the process 300 begins when the processor 204 receives a first markup language file (block 302). For example, the processor may read a first hypertext markup language file (HTML) file into an electronic document review application. The processor 204 then renames the first markup language file from a first name to a second different name (block 304). For example, the processor may rename the file from “ProductDescription.htm” to “0001.htm.” The processor 204 then optionally removes or modifies footer information and/or converts the first markup language file to a Page Description Format (PDF) (block 306). An example of a portion of an HTML file 702/704 before and after footer information is removed is illustrated in FIG. 7.

The processor 204 then stores the first markup language file in an electronic document review database using the second name (block 308). For example, the processor may store the document as “0001.htm” in a legal discovery application environment. The processor 204 then creates a data structure including an association between the first name and the second name (block 310). For example, the processor may store “ProductDescription.htm” in association with “0001.htm” in the electronic document review database.

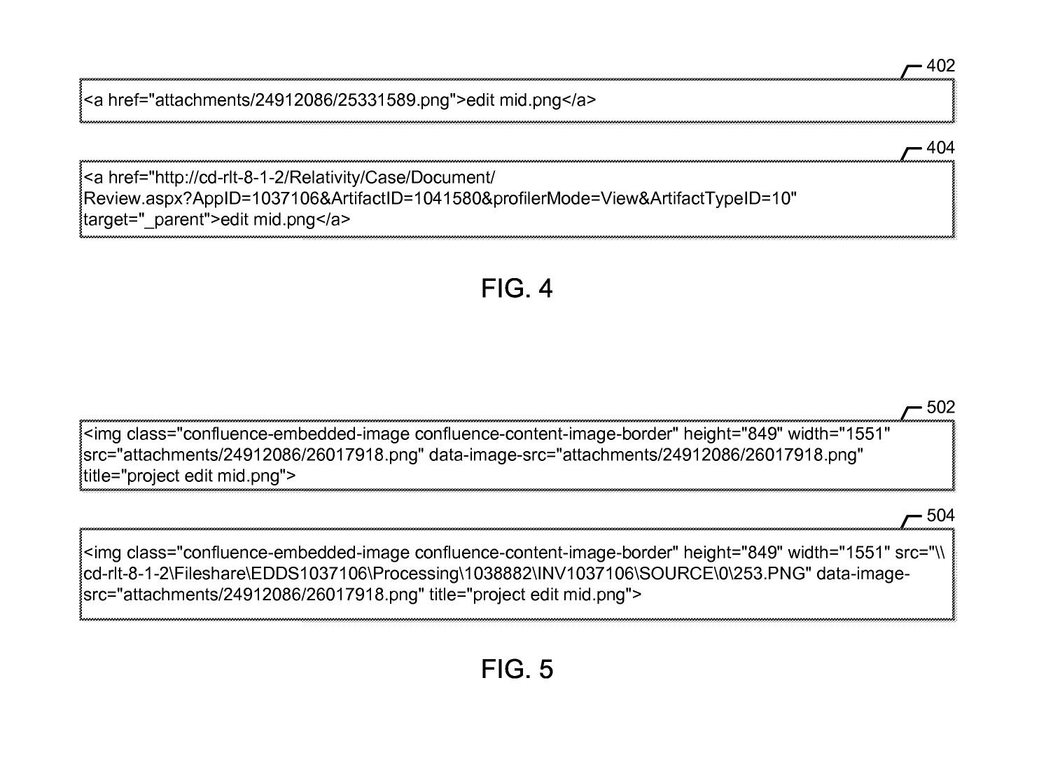

The processor 204 then determines that a link in a second different markup language file includes the first name (block 312). For example, the processor may find a hypertext reference (HREF) attribute in another HTML file that includes “ProductDescription.htm.” The processor 204 then creates a modified second markup language file including a modified link by modifying the link in the second markup language file to include the second name (block 314). For example, the processor may replace “ProductDescription.htm” in the second HTML file with “0001.htm.” Example of portions of HTML files before and after modification are illustrated in FIGS. 4-6.

The processor 204 then stores the modified second markup language file in the electronic document review database (block 316). For example, the processor may store the modified document in the legal discovery application environment. The processor 204 then receives a user selection of the modified link (block 318). For example, the user of the legal discovery application may click on the hyperlink containing “0001.htm” (block 318). The processor 204 then displays the first markup language file in response to receiving the user selection (block 320). For example, the processor may show the webpage “0001.htm.”

FIG. 4 is an example markup language file before and after having an HREF attribute modified. In this example, a portion of the HREF attribute is changed from “attachments/24912086/25331589.png” (a pointer to the original location of file) to “http://cd-rlt-8-1-2/Relativity/Case/Document/Review.aspx?AppID=1037106&ArtifactID=1041580&profile rMode=View&ArtifactTypeID=10” target=“_parent” (a pointer to the location of file in the document review application).

FIG. 5 is an example markup language file before and after having an IMG tag modified. In this example, a portion of the tag is changed from “attachments/24912086/26017918.png” (a pointer to the original location of file) to “\\cd-rlt-8-1-2\Fileshare\EDDS1037106\Processing\1038882\INV1037106\SOURCE\0\253.PNG” (a pointer to the location of file in the document review application).

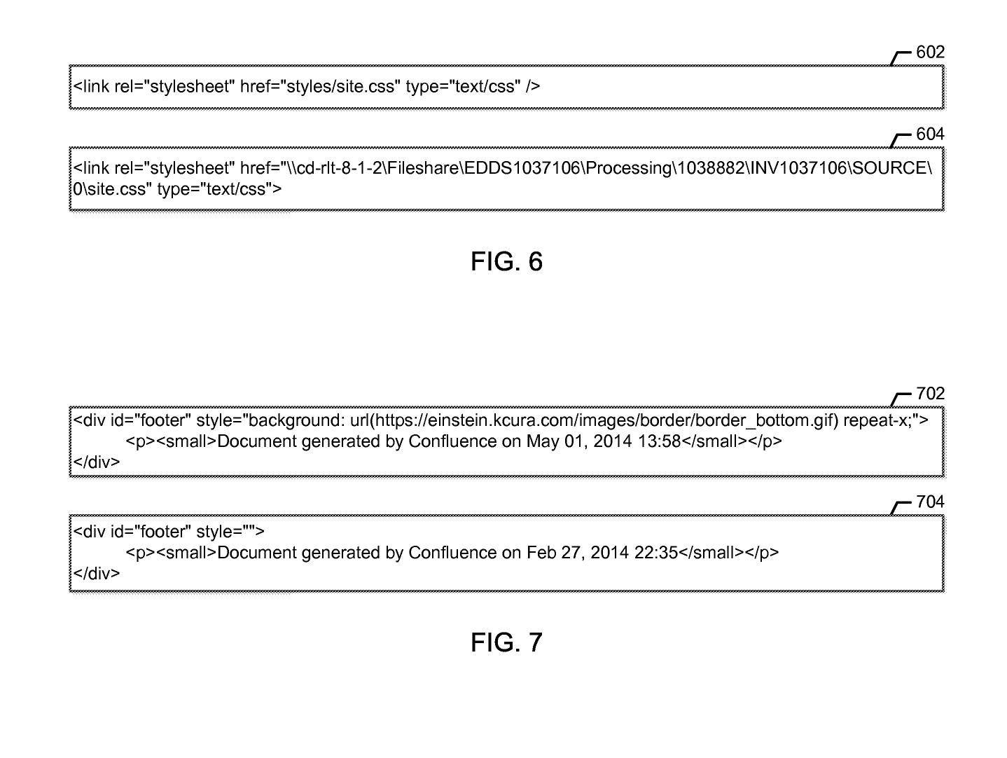

FIG. 6 is an example markup language file before and after having an style sheet link modified. In this example, a portion of the link is changed from “styles/site.css” (a pointer to the original location of file) to “\\cd-rlt-8-1-2\Fileshare\EDDS1037106\Processing\1038882\INV1037106\SOURCE0\site.css” (a pointer to the location of file in the document review application).

FIG. 7 is an example of a portion of an HTML file before and after footer information is removed. In this example, the style attribute “background: url(https://einstein.kcura.com/images/border/border_bottom.gif) repeat-x;” is removed.

In summary, persons of ordinary skill in the art will readily appreciate that methods and apparatus for modifying a plurality of markup language files have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of modifying a plurality of markup language files, the method comprising:
renaming a first markup language file from a first name to a second different name;
storing the first markup language file in an electronic document review database using the second name;
creating a data structure including an association between the first name and the second name;
determining that a link in a second different markup language file includes the first name;
modifying the link in the second markup language file to include the second name; and
storing the second markup language file in an association with the electronic document review database after modifying the link.

2. The method of claim 1, wherein the first markup language file comprises a hypertext markup language (HTML) file.

3. The method of claim 1, wherein the first markup language file comprises an extensible markup language (XML) file.

4. The method of claim 1, wherein the second name includes a serial number.

5. The method of claim 1, wherein the link with the second markup language file is part of a hypertext reference (HREF) tag.

6. The method of claim 1, wherein the link with the second markup language file is part of an image (IMG) tag.

7. The method of claim 1, wherein the link with the second markup language file is part of a cascading style sheet (CSS) tag.

8. The method of claim 1, wherein modifying the link includes modifying a file path.

9. The method of claim 1, further including converting the first markup language file to a page description (PDF) file.

10. The method of claim 1, further including receiving a user selection of the modified link, and displaying the first markup language file in response to receiving the user selection.

11. The method of claim 1, further including modifying footer information in the first markup language file.

12. The method of claim 1, further including removing footer information from the first markup language file.

13. An apparatus for modifying a plurality of markup language files, the apparatus comprising:
a processor;
a network interface operatively coupled to the processor; and
a memory device operatively coupled to the processor, the memory device storing instructions to cause the processor to:
rename a first markup language file from a first name to a second different name;
store the first markup language file in an electronic document review database using the second name;
create a data structure including an association between the first name and the second name;
determine that a link in a second different markup language file includes the first name;
modify the link in the second markup language file to include the second name; and
store the second markup language file in an association with the electronic document review database after modifying the link.

14. The apparatus of claim 13, wherein the first markup language file comprises a hypertext markup language (HTML) file.

15. The apparatus of claim 13, wherein the first markup language file comprises an extensible markup language (XML) file.

16. The apparatus of claim 13, wherein the second name includes a serial number.

17. The apparatus of claim 13, wherein the link with the second markup language file is part of a hypertext reference (HREF) tag.

18. The apparatus of claim 13, wherein the link with the second markup language file is part of an image (IMG) tag.

19. The apparatus of claim 13, wherein the link with the second markup language file is part of a cascading style sheet (CSS) tag.

20. The apparatus of claim 13, wherein modifying the link includes modifying a file path.

21. The apparatus of claim 13, wherein the instructions are structured to cause the processor to convert the first markup language file to a page description (PDF) file.

22. The apparatus of claim 13, wherein the instructions are structured to cause the processor to receive a user selection of the modified link, and display the first markup language file in response to receiving the user selection.

23. The apparatus of claim 13, wherein the instructions are structured to cause the processor to modify footer information in the first markup language file.

24. The apparatus of claim 13, wherein the instructions are structured to cause the processor to remove footer information from the first markup language file.

25. A non-transitory computer readable medium storing instructions structured to cause a computing device to:
rename a first markup language file from a first name to a second different name;
store the first markup language file in an electronic document review database using the second name;
create a data structure including an association between the first name and the second name;
determine that a link in a second different markup language file includes the first name;
modify the link in the second markup language file to include the second name; and
store the second markup language file in an association with the electronic document review database after modifying the link.

26. The computer readable medium of claim 25, wherein the first markup language file comprises an extensible markup language (XML) file.

27. The computer readable medium of claim 25, wherein the first markup language file comprises an extensible markup language (XML) file.

28. The computer readable medium of claim 25, wherein the second name includes a serial number.

29. The computer readable medium of claim 25, wherein the link with the second markup language file is part of a hypertext reference (HREF) tag.

30. The computer readable medium of claim 25, wherein the link with the second markup language file is part of an image (IMG) tag.

31. The computer readable medium of claim 25, wherein the link with the second markup language file is part of a cascading style sheet (CSS) tag.

32. The computer readable medium of claim 25, wherein modifying the link includes modifying a file path.

33. The computer readable medium of claim 25, wherein the instructions are structured to cause the processor to convert the first markup language file to a page description (PDF) file.

34. The computer readable medium of claim 25, wherein the instructions are structured to cause the processor to receive a user selection of the modified link, and display the first markup language file in response to receiving the user selection.

35. The computer readable medium of claim 25, wherein the instructions are structured to cause the processor to modify footer information in the first markup language file.

36. The computer readable medium of claim 25, wherein the instructions are structured to cause the processor to remove footer information from the first markup language file.
